(19) United States
(12) Patent Application Publication
(10) Pub. No.: US 2026/0135643 A1
(43) Pub. Date: May 14, 2026

(54) SUBFRAME BASED HYBRID AUTOMATIC REPEAT REQUEST FEEDBACK

(71) Applicant: Nokia Technologies Oy, Espoo (FI)

(72) Inventors: Tzu-Chung HSIEH, Naperville, IL (US); Jing Yuan SUN, Beijing (CN); Ping YUAN, Beijing (CN); Pingping WEN, Shanghai (CN)

(21) Appl. No.: 19/119,317

(22) PCT Filed: Oct. 10, 2022
(86) PCT No.: PCT/CN2022/124462

§ 371 Date: Apr. 8, 2025

(51) Int. Cl. H04L 1/1822; H04L 1/1829

(52) U.S. Cl. CPC H04L 1/1822; H04L 1/1854

(57) ABSTRACT

Systems, methods, apparatuses, and computer program products for dynamically enabling and disabling hybrid automatic repeat request feedback even for the same hybrid automatic repeat request process without changing downlink control information are provided. For example, a method can include determining a subframe index of a start of a transport block. The method can also include deciding provision of hybrid automatic repeat request feedback based on the determined subframe index.

### FIELD

Some example embodiments may generally relate to communications including mobile or wireless telecommunication systems, such as Long Term Evolution (LTE) or fifth generation (5G) radio access technology or new radio (NR) access technology, or other communications systems including subsequent generations of the same or similar standards. For example, certain example embodiments may generally relate to dynamically enabling and disabling hybrid automatic repeat request feedback even for the same hybrid automatic repeat request process without changing downlink control information.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on a 5G new radio (NR), but a 5G (or NG) network can also build on the E-UTRA radio. From release 18(Rel-18 ) onward, 5G is referred to as 5G advanced. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio. 6G is currently under development and may replace 5G and 5G advanced.

### SUMMARY

An embodiment may be directed to an apparatus. The apparatus can include at least one processor and at least memory storing instructions. The instructions, when executed by the at least one processor, can cause the apparatus at least to perform determining a subframe index of a start of a transport block. The instructions, when executed by the at least one processor, can also cause the apparatus at least to perform deciding provision of hybrid automatic repeat request feedback based on the determined subframe index.

An embodiment may be directed to an apparatus. The apparatus can include at least one processor and at least memory storing instructions. The instructions, when executed by the at least one processor, can cause the apparatus at least to perform configuring a user equipment with a configuration of relationship between a plurality of subframe indices and a plurality of hybrid automatic repeat request feedback options. The instructions, when executed by the at least one processor, also cause the apparatus at least to perform deciding a hybrid automatic repeat request action for the user equipment. The instructions, when executed by the at least one processor, further cause the apparatus at least to perform providing a transport block to the user equipment with a starting subframe index corresponding to the hybrid automatic repeat request action in the configuration.

An embodiment may be directed to a method. The method can include determining a subframe index of a start of a transport block. The method can also include deciding provision of hybrid automatic repeat request feedback based on the determined subframe index.

An embodiment may be directed to a method. The method can include configuring a user equipment with a configuration of relationship between a plurality of subframe indices and a plurality of hybrid automatic repeat request feedback options. The method can also include deciding a hybrid automatic repeat request action for the user equipment. The method further providing a transport block to the user equipment with a starting subframe index corresponding to the hybrid automatic repeat request action in the configuration.

An embodiment can be directed to an apparatus. The apparatus can include means for determining a subframe index of a start of a transport block. The apparatus can also include means for deciding provision of hybrid automatic repeat request feedback based on the determined subframe index.

An embodiment can be directed to an apparatus. The apparatus can include means for configuring a user equipment with a configuration of relationship between a plurality of subframe indices and a plurality of hybrid automatic repeat request feedback options. The apparatus can also include means for deciding a hybrid automatic repeat request action for the user equipment. The apparatus can further include means for providing a transport block to the user equipment with a starting subframe index corresponding to the hybrid automatic repeat request action in the configuration.

### BRIEF DESCRIPTION OF THE DRAWINGS

For proper understanding of example embodiments, reference should be made to the accompanying drawings, wherein:

FIG. 1 illustrates a signal flow of a method according to certain embodiments;

FIG. 2 illustrates example sequences with a four-subframe interval, according to certain embodiments;

FIG. 3 illustrates a communication structure with feedback provided, according to certain embodiments;

FIG. 4 illustrates a communication structure without feedback provided, according to certain embodiments; and

FIG. 5 illustrates an example block diagram of a system, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for providing dynamically enabling and disabling hybrid automatic repeat request feedback even for the same hybrid automatic repeat request process without changing downlink control information, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Certain embodiments may have various aspects and features. These aspects and features may be applied alone or in any desired combination with one another. Other features, procedures, and elements may also be applied in combination with some or all of the aspects and features disclosed herein.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

Hybrid automatic repeat request (HARQ) implemented in medium access control (MAC) protocol can serve as a retransmission system of fifth generation (5G) new radio (NR). HARQ protocol in downlink (DL) can be classified as an asynchronous protocol. DL transmission may require explicit signaling in the downlink control information (DCI). Once DL data is transmitted, the feedback can be sent from the user equipment (UE) to the base station or next generation node B (gNB) after each received transport block (TB).

If data decoding at the receiving end incurs an error, the UE can buffer the received data and can request a retransmission. The gNB may also need to buffer the transmitted data until an acknowledgement is received from the UE. In doing so, when a negative acknowledgment (NACK) is received, the gNB can retransmit the data to the UE. To correct erroneous packets, the UE can receive the retransmitted data and can combine the retransmitted data with the buffered data for another decoding attempt. Therefore, the HARQ mechanism can be based on a feedback as to success or failure of the downlink transmission. Feedback about success can be referred to as acknowledgment (ACK), while NACK can refer to feedback as to failure. In principle, feedback-based retransmission can operate using ACK only, NACK only, or both ACK and NACK. Thus, for example, the UE may feedback ACK when successfully decoding, but may feedback nothing otherwise in an ACK only approach. Likewise, the UE may feedback NACK when unsuccessfully decoding, but may feedback nothing otherwise in a NACK only approach.

HARQ can also be a stop and wait (SAW) automatic repeat request (ARQ) protocol implemented in multiple parallel processes. The HARQ protocol can use the receiver's ACK/NACK feedback to ensure reliable DL transmission in each parallel process. Multiple processes can be identified by a HARQ process number, harq_process, in the DCI carried by PDCCH.

A large round trip time (RTT) can incur HARQ stalling that prohibits the transmissions of other processes. In particular, non-terrestrial network (NTN) scenarios may have significant round trip delay, such as 541.46 ms for geosynchronous earth orbit (GEO) and 25.77 ms for low earth orbit (LEO) at 600 km altitude. Since the RTT may be considered large in NTN, one RTT may span many transmission time interval (TTIs), leading to a condition referred to as HARQ stalling. Disabling HARQ feedback may relieve the impact of HARQ stalling on UE data rates. On the other hand, not providing HARQ feedback may reduce reliability. In other words, there are reasons in favor of HARQ feedback but also challenges arising from HARQ feedback, particularly in scenarios with long RTTs.

Internet of things (IoT) over NTN in release 18(Rel-18 ) may take into account that a small number of HARQ processes may be used for narrowband (NB) IoT (NB-IoT). For NB-IoT devices with only one HARQ process, disabling HARQ feedback may prevent the eNB from knowing if a control message has been received by the UE. For IoT devices with two or more HARQ processes, the network may configure at least one process with feedback enabled to support acknowledgement of control messages and reliable data transmissions. However, for NB-IoT devices with only one HARQ process, the network may not get acknowledgement of signaling messages if HARQ feedback is disabled. For those devices, switching between feedback enabled and feedback disabled may be an technique to provide throughput and power saving benefits for the UE and to ensure reliable delivery of control messages.

IoT UE may operate in half-duplex mode. For half-duplex UEs, more DL scheduling opportunities may be created without HARQ feedback in the uplink (UL), which may increase DL throughput.

Throughput gain in NTN from disabling HARQ feedback has been analyzed. While every scenario may benefit in terms of throughput from disabling HARQ feedback, the scenarios with the biggest improvement may be GEO scenarios, while in general NB-IoT transmission with one HARQ process scenarios may have significant improvements even in LEO scenarios. This increase in throughput may be through the avoidance of HARQ stalling but also, in the case of LEO scenarios, from more scheduling opportunities from the omitted ACK/NACK transmission. Thus, disabling HARQ feedback for DL transmission may improve downlink throughput.

Thus, it may be beneficial to be able to disable HARQ procedures. Options for enhanced machine type communication (eMTC) and NB-IoT can be considered separately. In this discussion, NB-IoT is used as an example, but similar principles can be applied in other cases.

For IoT NTN, to configure/indicate enabling/disabling on HARQ feedback for downlink transmission, the enable/disabling may be per HARQ process via UE-specific radio resource control (RRC) signaling, may be per HARQ process via system information block (SIB) signaling, may be explicitly indicated in a field of downlink control information (DCI), may be implicitly determined by configured/indicated parameter(s) such as repetition number or transport block size (TBS), or may be per HARQ process via MAC control element (CE). Other options, combinations of these options, or other combinations may also be possible.

Certain embodiments provide a mechanism and procedures for disabling HARQ in an appropriate and efficient way.

As discussed above, in non-terrestrial networks, the long propagation time between UE and enhanced node B (eNB) or gNB through satellite can cause HARQ stalling, which can become a bottleneck that limits achievable user throughput. On the other hand, MAC CE messages sent by eNB/gNB to the UE, such as a discontinuous reception (DRX) command, timing advance command (TAC), or the like, may require a HARQ-ACK bit to confirm reception of the commands before those commands can take effect. RRC signaling messages may also require HARQ-ACK to confirm that the commands have been received. In this context, reception can refer to successful decoding as opposed to reception with errors.

In release 17(Rel-17 ) NR, HARQ feedback can be disabled semi-statically by RRC configuration on a per HARQ process basis. The network can configure some processes with feedback enabled to be used for control message transmission, and some processes with feedback disabled to support continuous data transmission. This semi-static disabling may not work as well for NB-IoT devices, because those low complexity devices may support either one or two HARQ processes. For a UE with only one HARQ process especially, the feedback may not be able to be disabled semi-statically without affecting MAC CE and RRC signaling mechanisms.

Furthermore, HARQ feedback may be used for the adaptation of transmission resources, such as modulation and coding scheme (MCS) and codeword repetitions. Insufficient HARQ feedback may affect link performance. For an NB-IoT connection, a scheduling request (SR) may be sent together with HARQ-ACK on the same UL resource. If HARQ feedback is disabled, NB-IoT devices may resort to narrowband physical random access channel (NPRACH) to send SR. Such use of NPRACH may risk depleting NPRACH capacity needed for initial access.

Dynamically switching feedback on and off by additional DCI indications would require changing DCI formats and adding to the UE's complexity for DCI detection.

Certain embodiments provide a mechanism and procedures that may permit a network to dynamically enable and disable HARQ feedback even for the same HARQ process without changing DCI. Certain embodiments avoid issues associated with NB-IoT devices having few HARQ processes operating in the NTN scenario.

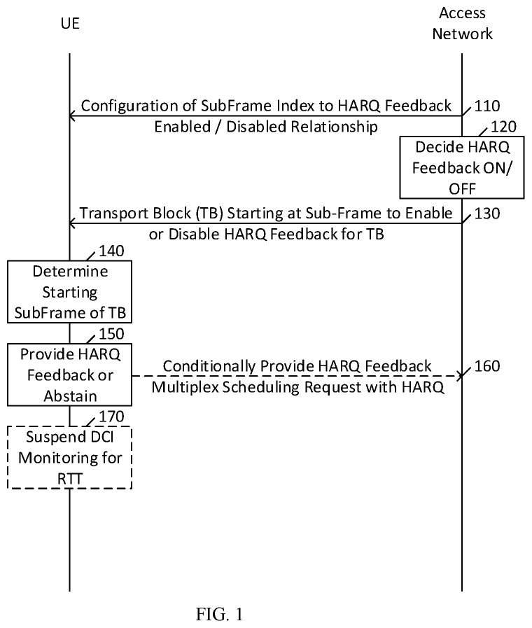

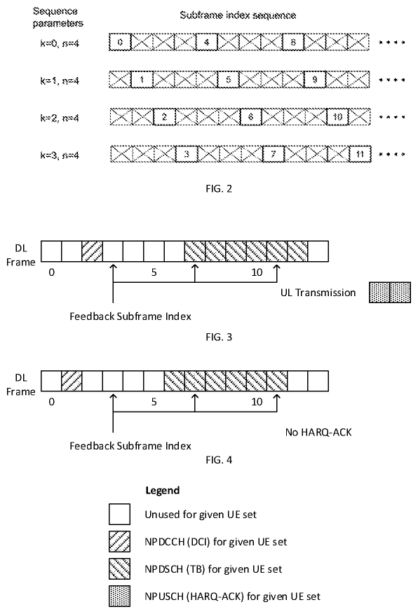

FIG. 1 illustrates a signal flow of a method according to certain embodiments. As shown in FIG. 1, a method can include, at 110, configuring a user equipment with a configuration of relationship between a plurality of subframe indices and a plurality of hybrid automatic repeat request feedback options. FIG. 2, discussed below, provides some examples of how such configuration may be accomplished. As other alternatives, the UE may be preconfigured or configured by higher layer signaling.

At 120, a device of the access network, such as an eNB or gNB, may decide whether to enable or disable HARQ feedback. This decision may be made at various granularities. For example, the decision may be made at a cell level, a UE level, or a transport block level. The decision may take into account the type of UE with which communications are desired. The decision may further take into account whether a control message such as MAC CE or RRC message is to be transported over the transport block. The decision may also take into account whether the UE is located near cell center or cell edge. Thus, the decision can at 120 can decide a hybrid automatic repeat request action for the user equipment. The decision may be based on whether there is a control message to be transmitted on the scheduled TB and whether the network needs HARQ-ACK for link adaptation, such as for adjustment of MCS or codeword repetitions. The action may be to enable HARQ feedback or disable HARQ feedback. In this example, disabling HARQ feedback can refer to completely avoiding the use of HARQ feedback for one or more downlink communication, rather than applying ACK-only or NACK-only feedback. Assigning a sequence to the UE for communication of the TB can take place at 110 through the configuration message. The sequence can be indicated by the parameters k and n, discussed above. The UE can then receive the TB in the assigned sequence used to communicate the TB. The configuration may identify to the UE the assigned sequence for the UE. After the configuration, the UE may know what feedback action to take for a received TB based on the TB's starting subframe. The network can also know how to schedule the TB on the subframes according to the NW's feedback decision at 120.

At 130, the access network can schedule a transport block to the user equipment with a starting subframe index corresponding to the hybrid automatic repeat request action in the configuration. Thus, if feedback is desired, the TB block may begin at a first subframe index, and if feedback is not desired, the TB block may begin at a second subframe index, different from the first subframe index. If the TB begins at any index in the sequence, a HARQ feedback may be required. For example, considering the sequence with k=1, n=4, {1, 5, 9, 13, . . . } , the network can schedule a TB that begins at any subframe index in the sequence, either 1, 5, 9, or 13, and the UE can accordingly send a feedback for the TB. In certain embodiments, if the TB begins at any subframe index not in the sequence, HARQ feedback is not to be sent. In the example of k=1, n=4, {1, 5, 9, 13, . . . } , if the TB begins from a subframe with an index not in {1, 5, 9, 13, . . . } , for example, a subframe with index 7 or 10, there is no feedback. Thus, first and second are just labels for distinguishing feedback desired indices from feedback undesired indices, without limiting the index to being the first index or second index of a sequence, and without limiting the index to being index 1 or index 2. Knowledge of which subframe index corresponds to enabling HARQ feedback and which subframe index corresponds to disabling HARQ feedback can be provided to the UE via the configuration at 110. The index can refer to the subframe index, which can be an indication of system timing for a subframe. The subframe index can run from 0 to 10239 over a cycle of 10.24 seconds.

The offset parameter k and the interval parameter n are parameters characterizing a subframe index sequence for the UE in the configuration at 110. A TB on NPDSCH may occupy many subframes because of repetitions. In certain embodiments, all the UE has to do is determine the subframe index at the start of the TB (NPDSCH) and check whether that index is in the UE's configured sequence. If the starting index is in the sequence then HARQ feedback should be sent, otherwise HARQ feedback should not be sent in this embodiment. Optionally, the opposite convention could be used, such that if the start of the TB is in the configured sequence HARQ feedback should not be sent, otherwise HARQ feedback should be sent. FIGS. 3 and 4, discussed below, show examples with the same subframe index sequence, k=3, n=4, {3, 7, 11, . . . } , as indicated by the arrows. Transmission of HARQ-ACK in FIG. 3 may be due to the TB starting at index 7, which is in the sequence. By contrast, the absence of transmission of HARQ-ACK in FIG. 4 may be due to the TB starting at index 6, which is not in the sequence.

The network can also allocate uplink resources for hybrid automatic repeat request feedback for the user equipment based on the hybrid automatic repeat request action. For example, if the action is to enable HARQ feedback, then HARQ feedback resources in the uplink may be allocated by the network, but if the action is to disable HARQ feedback, then HARQ feedback resources may not be allocated by the network.

In the example of FIG. 1, the transport block at 130 may include at least one control element of medium access control or at least one radio resource control message. In such case, HARQ feedback may be enabled.

A hybrid automatic repeat request acknowledgment resource field in downlink control information may be used by the network to indicate uplink HARQ feedback resource based on the deciding the hybrid automatic repeat request action 120 being to a decision to enable hybrid automatic repeat request feedback. Otherwise, such a field in DCI may be omitted or reused for another purpose.

At 140, the UE may determine a subframe index of a start of a transport block. The UE may be a NB-IoT device, as mentioned above. The UE can, at 150, decide to provide hybrid automatic repeat request feedback based on the determined subframe index. For example, the UE may have received the configuration provided at 110 of a relationship between a plurality of subframe indices and a plurality of hybrid automatic repeat request feedback options. Thus, the deciding can be performed based on the configuration. For example, the deciding can include looking up, in the configuration, a hybrid automatic repeat request action corresponding to the subframe index of the start of the transport block to the configuration. The HARQ action may be enabling HARQ feedback or disabling HARQ feedback from the network perspective and providing HARQ feedback or not providing HARQ feedback from the UE perspective.

If the UE operates to provide HARQ feedback at 160, the UE can optionally multiplex a scheduling request with hybrid automatic repeat request feedback on the UL resource indicated by the DCI based on the deciding to provide the hybrid automatic repeat request feedback.

If the UE operates to provide HARQ feedback or for other reasons, at 170 the UE can discontinue monitoring downlink control information for a round trip time upon providing hybrid automatic repeat request feedback. In the case of communication with a GEO satellite, this may allow the UE to limit power usage, as the UE may not expect to receive further communication until the HARQ feedback is received, processed, and retransmissions are transmitted by the satellite.

Thus, in certain embodiments, the enabling or disabling of HARQ feedback for a received transport block can be determined by the subframes used for the transmission of the TB. The network can control if a TB is to be acknowledged by selecting subframe(s) used for transmission. The UE can determine if HARQ feedback should be sent for a received TB, by the subframe(s) where the TB is scheduled.

The network can configure a sequence of subframe indices to determine whether HARQ feedback should be sent. The subframe index can be the order of a subframe in the DL frame structure. The sequence can be determined by an offset parameter k and an interval parameter n. A group of UEs can be assigned to a sequence, considering load balance among different sequences. Thus, the decision at 120 in FIG. 1 may be made by associating a given UE with a group having a particular sequence structure for enabling or disabling HARQ feedback. The decision to group the UE may be based on the type of UE as well as load balancing considerations and other considerations.

The UE can determine whether HARQ feedback is to be sent for a TB based on the subframes where the TB is transmitted. For example, if the TB begins from a subframe whose subframe index falls in the assigned sequence, the UE can send a HARQ feedback. Otherwise, the UE may avoid sending HARQ feedback. A HARQ-ACK resource field in the DCI may only be used for UL resource indication when the UE is to send HARQ feedback. When the UE has a scheduling request (SR) to send, UE can multiplex SR and HARQ feedback on the same UL resource.

The network can send MAC CE and RRC messages on the TB at 130 with HARQ feedback enabled according to the UE's assigned sequence. The network may only need to allocate UL resource for HARQ feedback for those TBs with HARQ feedback according to the UE's assigned sequence. After sending HARQ feedback, the UE may stop monitoring PDCCH (DCI) to save power until the round-trip time has passed if the UE has only one HARQ process. Monitoring PDCCH may be needed if the UE has multiple HARQ processes, because the NW may schedule data transmission on other processes.

The UE may always be aware of the current system frame number (SFN) and subframe number in the DL system frame. In the frequency division duplex (FDD) long term evolution (LTE) frame structure for NB-IoT, for example, a SFN can identify a 10 ms radio frame in a 10.24 s cycle, and each radio frame can include ten 1 ms subframes, as described in third generation partnership project (3GPP) technical specification (TS) 36.211. Current SFN and subframe number can be derived from information in physical broadcast channel (PBCH) and synchronization signals. The network can take advantage of the UE's unequivocal understanding of SFN and subframe number to indicate if a HARQ feedback is required for a transport block (TB) according to the subframe in which the TB transmission begins.

The index of a subframe can be computed from SFN (SFN=0, 1, 2, . . . , 1023) and subframe number i (i=0, 1, 2, . . . , 9) as t=SFN * 10+i, assuming there are 10 subframes in one radio frame. The network can assign a sequence of subframe indices {k, k+n, k+2n, k+3n, . . . } for HARQ feedback determination. If a TB is scheduled beginning from subframe with an index in the specific sequence, then HARQ feedback is required for that TB. If a TB is scheduled beginning from subframe with an index not in the specific sequence, then HARQ feedback is not required for that TB. The sequence for HARQ feedback decision consists of two parameters: k is the index offset and n is the interval. FIG. 2 illustrates example sequences with a four-subframe interval, according to certain embodiments.

The network can plan a set of sequences with a variety of intervals and divide the connected UEs into groups according to their demand for HARQ feedback, then assign a group of UEs to one sequence. The indices in a sequence can represent scheduling opportunities for TBs with HARQ feedback. The smaller the parameter n, the more scheduling opportunities for HARQ feedback. To avoid HARQ stalling, the network may prefer to schedule payload data without feedback using opportunities not represented in the sequence. In this case, the larger the parameter n, the more scheduling opportunities for payload data and the higher the throughput.

In the example sequences of FIG. 2, the offset parameter is different among the groups, but the interval parameter is the same. In another example, the interval parameter could also be different in different groups.

FIG. 3 illustrates a communication structure with feedback provided, according to certain embodiments. By contrast, FIG. 4 illustrates a communication structure without feedback provided, according to certain embodiments. Thus, FIGS. 3 and 4 represent two distinct ways of scheduling a transport block that can be used respectively to enable or disable HARQ feedback by the UE.

When a UE detects a DCI in NPDCCH that signals transmission of a transport block in NPDSCH, the UE can know the subframe index at the start of NPDSCH. The UE can check if the index is in the UE's assigned sequence. The NPDSCH may start from subframe to and the assigned sequence can be represented by {k, n}. Subframe index t0 can be in the sequence if t0 mod n=k. Only when this condition is met the UE may send HARQ feedback, in this example. The UL resource for HARQ feedback may be indicated in the HARQ-ACK resource field of the DCI. When HARQ feedback is not required, such as when t0 mod n≠k, the HARQ-ACK resource field can be ignored or used for another purpose.

When the UE determines that a HARQ feedback should be sent, the UE can check whether the UE has any scheduling request(s) for UL data transmission. A scheduling request indication, for example one bit, can be multiplexed with an ACK/NACK bit on the same UL HARQ-ACK resource.

In NTN, the subframe offset between DL and UL can be indicated in system information block (SIB) as K_{offset}. For HARQ operation, the round trip time between the UE sending feedback and receiving a next data transmission may be K_{offset}+X, where X is the eNB processing time. For NB-IoT with one HARQ process, the UE can stop monitoring NPDCCH for a duration of K_{offset} +X subframes after sending feedback to reduce power consumption, or for any other desired reason.

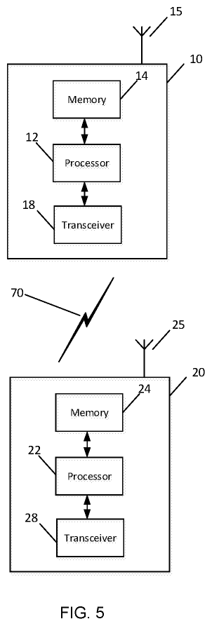

FIG. 5 illustrates an example of a system that includes an apparatus 10, according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), TRP, HAPS, integrated access and backhaul (IAB) node, and/or a WLAN access point, associated with a radio access network, such as a LTE network, 5G or NR. In some example embodiments, apparatus 10 may be gNB or other similar radio node, for instance.

It should be understood that, in some example embodiments, apparatus 10 may include an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a mid-haul interface, referred to as an F1 interface, and the DU(s) may have one or more radio unit (RU) connected with the DU(s) over a front-haul interface. The DU may be a logical node that includes a subset of the gNB functions, depending on the functional split option. It should be noted that one of ordinary skill in the art would understand that apparatus 10 may include components or features not shown in FIG. 5.

As illustrated in the example of FIG. 5, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 5, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to dynamically enabling and disabling hybrid automatic repeat request feedback even for the same hybrid automatic repeat request process without changing downlink control information.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be include any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of global system for mobile communications (GSM), narrow band Internet of Things (NB-IoT), LTE, 5G, WLAN, Bluetooth (BT), Bluetooth Low Energy (BT-LE), near-field communication (NFC), radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (via an uplink, for example).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device), or an input/output means.

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be or may be a part of a network element or RAN node, such as a base station, access point, Node B, eNB, gNB, TRP, HAPS, IAB node, relay node, WLAN access point, satellite, or the like. In one example embodiment, apparatus 10 may be a gNB or other radio node, or may be a CU and/or DU of a gNB. According to certain embodiments, apparatus 10 may be controlled by memory 14 and processor 12 to perform the functions associated with any of the embodiments described herein. For example, in some embodiments, apparatus 10 may be configured to perform one or more of the processes depicted in any of the flow charts or signaling diagrams described herein, such as those illustrated in FIGS. 1-4, or any other method described herein. In some embodiments, as discussed herein, apparatus 10 may be configured to perform a procedure relating to providing dynamically enabling and disabling hybrid automatic repeat request feedback even for the same hybrid automatic repeat request process without changing downlink control information, for example.

FIG. 5 further illustrates an example of an apparatus 20, according to an embodiment. In an embodiment, apparatus 20 may be a node or element in a communications network or associated with such a network, such as a UE, communication node, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 5.

As illustrated in the example of FIG. 5, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 5, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can include any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDM symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, apparatus 20 may be a UE, SL UE, relay UE, mobile device, mobile station, ME, IoT device and/or NB-IoT device, or the like, for example. According to certain embodiments, apparatus 20 may be controlled by memory 24 and processor 22 to perform the functions associated with any of the embodiments described herein, such as one or more of the operations illustrated in, or described with respect to, FIGS. 1-4, or any other method described herein. For example, in an embodiment, apparatus 20 may be controlled to perform a process relating to providing dynamically enabling and disabling hybrid automatic repeat request feedback even for the same hybrid automatic repeat request process without changing downlink control information, as described in detail elsewhere herein.

In some embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. Certain embodiments may provide various benefits and/or advantages. For example, certain embodiments may provide a way to facilitate control message acknowledgement and link adaptation when disabling HARQ feedback is desired to avoid throughput limiting stalling. Certain embodiments may have the advantages of not having to modifying DCI or re-interpret fields. Certain embodiments may alleviate the application of Rel-17 RRC configuration solution to NB-IoT devices despite the few HARQ processes of such NB-IoT devices.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations required for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium. The term “non-transitory” as used herein, is a limitation of the medium itself (i.e. tangible, not a signal) as opposed to a limitation on data storage persistency (e.g. RAM vs. ROM).

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

### PARTIAL GLOSSARY

ACK acknowledge
ARQ Automatic Repeat reQuest
BLER Block Error Rate
CRC cyclic redundancy check
DCI downlink control information
DL downlink
HARQ Hybrid Automatic Repeat reQuest
GEO geosynchronous equatorial orbit
gNB gNodeB
MAC medium access control
MAC CE MAC Control Element
MCS Modulation and Coding Scheme
NACK negative acknowledge
NTN non-terrestrial network
NR New Radio
UE user equipment
LEO low Earth orbit
PDCCH physical downlink control channel
PDSCH physical downlink shared channel
RTT round trip time
RNTI Radio Network Temporary Identifier
SAW stop and wait
SR Scheduling Request
SFN System Frame Number
TB Transport Block
TTI Transmission Time Interval
UL Uplink

We claim:

1. An apparatus, comprising:
at least one processor; and
at least one memory storing instructions, that when executed by the at least one processor, cause the apparatus at least to perform
determining a subframe index of a start of a transport block; and
deciding provision of hybrid automatic repeat request feedback based on the determined subframe index.

2. The apparatus of claim 1, wherein the instructions, when executed by the at least one processor, also cause the apparatus at least to perform
receiving a configuration of relationship between a plurality of subframe indices and a plurality of hybrid automatic repeat request feedback options, wherein the deciding is performed based on the configuration.

3. The apparatus of claim 2, wherein the deciding comprises looking up, in the configuration, a hybrid automatic repeat request action corresponding to the subframe index of the start of the transport block to the configuration.

4. The apparatus of claim 1, wherein the instructions, when executed by the at least one processor, also cause the apparatus at least to perform
multiplexing a scheduling request with hybrid automatic repeat request feedback based on the deciding to provide the hybrid automatic repeat request feedback.

5. The apparatus of claim 4, wherein the hybrid automatic repeat request feedback and the scheduling request are transmitted on an uplink resource indicated by downlink control information.

6. The apparatus of claim 1, wherein the instructions, when executed by the at least one processor, also cause the apparatus at least to perform
discontinuing monitoring downlink control information for a round trip time upon providing hybrid automatic repeat request feedback based on the deciding.

7. An apparatus, comprising:
at least one processor; and
at least one memory storing instructions, that when executed by the at least one processor, cause the apparatus at least to perform
configuring a user equipment with a configuration of relationship between a plurality of subframe indices and a plurality of hybrid automatic repeat request feedback options;
deciding a hybrid automatic repeat request action for the user equipment; and
providing a transport block to the user equipment with a starting subframe index corresponding to the hybrid automatic repeat request action in the configuration.

8. The apparatus of claim 7, wherein the instructions, when executed by the at least one processor, also cause the apparatus at least to perform
allocating uplink resources for hybrid automatic repeat request feedback for the user equipment based on the hybrid automatic repeat request action.

9. The apparatus of claim 7, wherein the deciding comprises deciding to enable hybrid automatic repeat request feedback based on the transport block comprising at least one control element of medium access control or at least one radio resource control message.

10. The apparatus of claim 7, wherein the instructions, when executed by the at least one processor, also cause the apparatus at least to perform
using a hybrid automatic repeat request acknowledgment resource field in downlink control information based on the deciding the hybrid automatic repeat request action to be enabling hybrid automatic repeat request feedback.

11. A method, comprising:
determining a subframe index of a start of a transport block; and
deciding provision of hybrid automatic repeat request feedback based on the determined subframe index.

12. The method of claim 11, further comprising:
receiving a configuration of relationship between a plurality of subframe indices and a plurality of hybrid automatic repeat request feedback options, wherein the deciding is performed based on the configuration.

13. The method of claim 12, wherein the deciding comprises looking up, in the configuration, a hybrid automatic repeat request action corresponding to the subframe index of the start of the transport block to the configuration.

14. The method of claim 11, further comprising:
multiplexing a scheduling request with hybrid automatic repeat request feedback based on the deciding to provide the hybrid automatic repeat request feedback.

15. The method of claim 14, wherein the hybrid automatic repeat request feedback and the scheduling request are transmitted on an uplink resource indicated by downlink control information.

16. The method of claim 11, further comprising:
discontinuing monitoring downlink control information for a round trip time upon providing hybrid automatic repeat request feedback based on the deciding.

17-32. (canceled)
